(19) United States
(12) Patent Application Publication
(10) Pub. No.: US 2024/0183623 A1
(43) Pub. Date: Jun. 6, 2024

(54) SALT HYDRATE COMPOSITES FOR THERMOCHEMICAL ENERGY STORAGE AND METHODS OF MAKING THEREOF

(71) Applicant: The Regents of the University of California, Oakland, CA (US)

(72) Inventors: Sumanjeet Kaur, Pinole, CA (US); Ravi Prasher, Danville, CA (US); Andrew Martin, Berkeley, CA (US); Drew Lilley, Berkeley, CA (US); Alondra Perez, Berkeley, CA (US)

(21) Appl. No.: 18/522,851

(22) Filed: Nov. 29, 2023

Related U.S. Application Data
(60) Provisional application No. 63/386,237, filed on Dec. 6, 2022.
(60) Provisional application No. 63/589,482, filed on Oct. 11, 2023.

(51) Int. Cl. F28D 20/00; C08K 3/24

(52) U.S. Cl. CPC F28D 20/003; C08K 3/24; C08K 2201/005

(57) ABSTRACT

This disclosure provides systems, methods, and apparatus related to salt hydrate composites. In one aspect, a method includes mixing a salt hydrate, a matrix material, and a binder to form a mixture. The mixture is ball milled. The mixing operation and the ball milling operation are performed without water.

### RELATED APPLICATIONS

This application claims priority to U.S. Provisional Patent Application No. 63/386,237, filed Dec. 6, 2022 and to U.S. Provisional Patent Application No. 63/589,482, filed Oct. 11, 2023, both of which are herein incorporated by reference.

### STATEMENT OF GOVERNMENT SUPPORT

This invention was made with government support under Contract No. DE-AC02-05CH11231 awarded by the U.S. Department of Energy. The government has certain rights in this invention.

### TECHNICAL FIELD

This disclosure relates generally to thermochemical energy storage and more particularly to salt hydrate composites for thermochemical energy storage.

### BACKGROUND

Scalable, affordable, and sustainable energy storage solutions are required to allow for wider adoption of renewable electricity. So far, many energy storage solutions have been explored for both short- and long-term energy storage, but the on-site energy storage needs for the building sector are mostly overlooked. This is despite the fact that buildings use 40% of global energy and account for approximately 60% of the consumption of world's electricity, which are responsible for 33% of greenhouse gas emissions.

Currently, the electricity storage technologies such as Li-ion batteries are the most common option for energy storage in buildings, despite the fact that heating and cooling are the major end uses of energy in the building. It is projected that by 2050, the heating and cooling (thermal loads) will account for more than 50% of the energy demand in buildings. Storing energy using thermal energy storage (TES) technologies is an attractive alternative to Li-ion batteries as they could provide affordable, sustainable, and more energy-efficient solution for on-site energy storage in buildings. In terms of functionality, TES can be charged by consuming electricity, then can be discharged as thermal energy during peak hours to displace later electricity use. Further, TES could leverage the effect of diurnal swings or fluctuation in ambient temperature to significantly improve its efficiency.

TES can be broadly divided into sensible, phase-change materials (PCMs) and thermochemical materials (TCMs). TCMs have a fundamental advantage of having significantly higher theoretical energy densities (e.g., 200-600 kWh m⁻³) than sensible and latent PCMs (e.g., 50-150 kWh m⁻³) because the energy is stored in the solid-gas water reaction without any liquid-solid phase change involved (and thus differentiating TCMs from PCMs). For building applications, a low charge-discharge temperature is highly desirable in TES materials, and TCMs can meet this need. TCMs cover a wide array of materials that undergo the reaction of AB+heat↔A+B. Some example of “B” include water, ammonia, hydroxide, oxide, etc.

### SUMMARY

Described herein is a method of producing salt hydrates composite for stable thermochemical energy storage for long-term cycling. The salt hydrate composites are fabricated using a dry mixing method.

Details of one or more embodiments of the subject matter described in this specification are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1A shows an energy density comparison between various thermal energy storage materials including phase change materials (PCM), water-based adsorption thermochemical materials (TCMs), and absorption TCMs. FIG. 1B shows an illustration of the use the charge-discharge cycle of salt hydrates in buildings. Salt hydrates can be dehydrated using the energy generated through solar power and then rehydrated at night with outside humid air or a humidifier.

FIG. 2 shows an example of a flow diagram illustrating a manufacturing process for a salt hydrate composite.

### DETAILED DESCRIPTION

Reference will now be made in detail to some specific examples of the invention including the best modes contemplated by the inventors for carrying out the invention. Examples of these specific embodiments are illustrated in the accompanying drawings. While the invention is described in conjunction with these specific embodiments, it will be understood that it is not intended to limit the invention to the described embodiments. On the contrary, it is intended to cover alternatives, modifications, and equivalents as may be included within the spirit and scope of the invention as defined by the appended claims.

In the following description, numerous specific details are set forth in order to provide a thorough understanding of the present invention. Particular example embodiments of the present invention may be implemented without some or all of these specific details. In other instances, well known process operations have not been described in detail in order not to unnecessarily obscure the present invention.

Various techniques and mechanisms of the present invention will sometimes be described in singular form for clarity. However, it should be noted that some embodiments include multiple iterations of a technique or multiple instantiations of a mechanism unless noted otherwise.

The terms “about” or “approximate” and the like are synonymous and are used to indicate that the value modified by the term has an understood range associated with it, where the range can be ±20%, ±15%, ±10%, ±5%, or ±1%. The terms “substantially” and the like are used to indicate that a value is close to a targeted value, where close can mean, for example, the value is within 80% of the targeted value, within 85% of the targeted value, within 90% of the targeted value, within 95% of the targeted value, or within 99% of the targeted value.

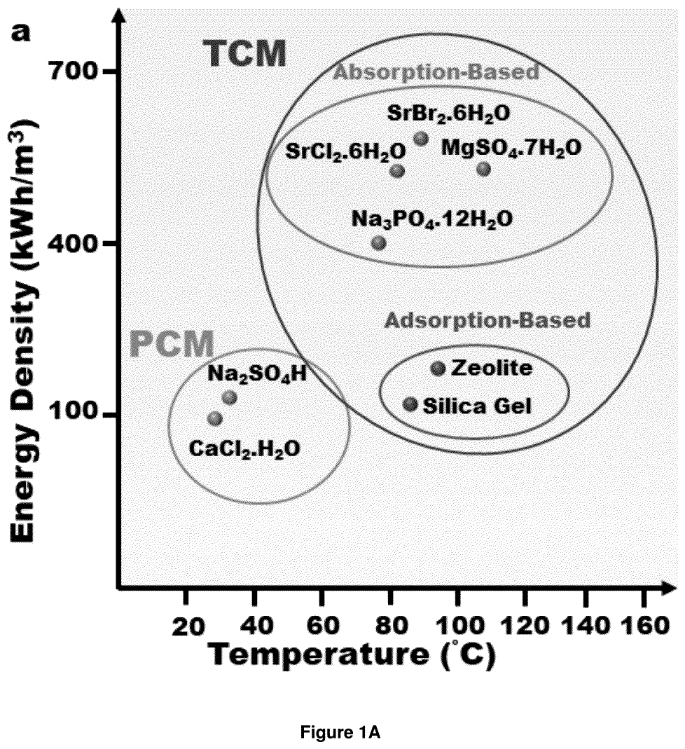

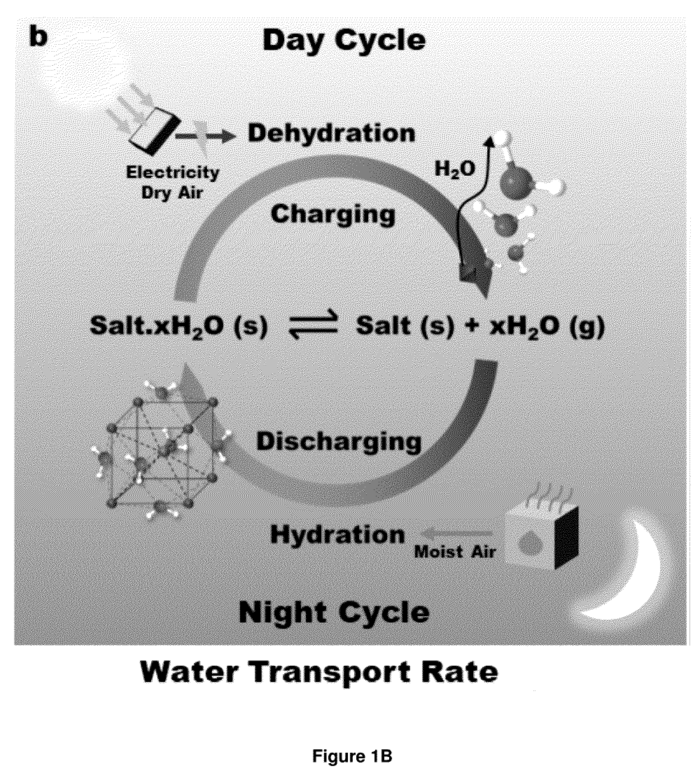

Described herein are thermochemical materials (TCMs) with water reactions. In the class of water-reacting TCMs, there exist: (1) adsorption materials (e.g., zeolites and silica gels) where the reversible reaction is based on weak van der Waals interactions between solid and gas (physisorption, energy density 100-200 kWh m⁻³) and is limited to the surface of the solid; and (2) absorption materials where energy is stored or released by reversible solid-gas reaction (chemisorption), which involves breaking and restoring strong bonds (e.g., covalent bonds) between the constituents throughout the bulk of the material. Absorption materials such as inorganic salts (e.g., SrCl₂·6H₂O, MgSO₄·7H₂O, K₂CO₃·1.5H₂O), which have their water bonded within the structure, have higher energy densities (approximately 500 kWh m⁻³) when compared with adsorption-based materials (approximately 200 kWh m⁻³), as shown in FIG. 1A.

Described herein are inorganic salt hydrate TCMs that are uniquely suited for on-site TES for buildings because apart from having high energy densities, they have negligible self-discharge and can be charged at temperatures below 100° C. Further, since they are made from earth abundant materials, they are economical. FIG. 1B shows an example for the implementation of salt hydrates as TCM-thermal storage that can be charged using solar energy or excess grid electricity and discharged for thermal end uses in buildings, such as space and water heating, by harvesting moist air from the surroundings.

Despite the promising attributes of salt hydrates performing as TCMs, they are not widely used as TCMs. Instead, most of the research in salt hydrates is limited to their use as PCMs. One of the issues with TCMs is their its poor multi-cyclic efficiency, with most of the research work showing significant drop in energy densities of salt hydrates after about 20 cycles to 50 cycles. This drop is mainly related to material-level instabilities (e.g., pulverization, agglomeration, change in porosity), as salt hydrates undergo large volumetric changes during each cycle (i.e., each hydration/rehydration cycle).

To accommodate these instabilities, many studies have been performed on generating TCM composites to improve the structural integrity and stability for long-term cycling. Incorporation of certain host matrices into TCM composites also improves overall thermal and mass transport properties. Inert host matrices such as expanded graphite, vermiculite, silica gel, metal organic frameworks, for example, are often selected for these purposes.

Typically, a solution-based impregnation (wet) method is used to make TCM composites. The salt hydrate is turned into a saturated solution in water (overhydration past the deliquescence point) and the host matrix is added to this solution. The saturated solution impregnates the nanopores of the host matrix. Once a homogeneous slurry is obtained, it is then dried to make the TCM composite. This method, however, often results in agglomeration of salt hydrate particles during the drying process, which reduces the mass transport and results in poor performance of the composite.

As described herein, solid-state mixing can be used to mitigate the issues associated with wet mixing. Solid-state mixing of a salt hydrate with an inert matrix (dry mixing) is desirable as it resolves the issue of agglomeration of salt hydrates and also reduces the energy and cost associated with the drying step of the wet manufacturing process.

With dry mixing, one issue that is faced during cycling is the pulverization of the TCM salt hydrates. Many studies have reported the pulverization of TCMs with cycling, but none have provided a mechanistic understanding and physical insights into predicting such behavior, i.e., whether the material will continue to pulverize or if there is a critical size below which the particle is stable. Processes such as coating and encapsulation of salt hydrates and embedding salts hydrates into inert matrices have been performed to improve long-term performance and stability of the salt hydrates; however, the mechanical instabilities of pristine salts with cycling have not been investigated. In a dry mixing process, since the salt hydrates are not dissolved in the water, it is important to know the stable size (or critical size or pulverization limit) of salt hydrates before making the composite to prevent structural changes in the composites during thermal cycling.

In typical salt hydrates, water can account for approximately ¼ to ½ of the mass of the salt hydrate itself. For example, in a commonly investigated salt (MgSO₄·7H₂O), water occupies approximately 51% of the salt hydrate's mass. This causes large volume and porosity changes when water molecules are removed and reintroduced (approximately 71.8% volume reduction during dehydration).

Previous investigations on the transition of TCM salt hydrates between various hydrate phases has shown that different salts may exhibit different transition mechanisms during both dehydration and hydration. The hydration of the salt can follow different pathways (i.e., a direct solid-solid transition or a dissolution and a recrystallization process); however, dehydration for most salts is via diffusion of water molecules out of the salt hydrate crystal. This removal of water from the crystal induces a solid-state transformation and causes a degree of mechanical stress and strain on the crystal itself, causing defects (i.e., dislocation and formation of cracks) that can result in the self-pulverization of salt. Thus, while both hydration and dehydration may contribute to the deterioration of salt hydrates over cycling due to the large morphological changes, dehydration is considered to be the largest contributor toward the pulverization of salt hydrates.

Most salt hydrate composites are fabricated using wet mixing methods. Described herein is a dry mixing process to fabricate salt hydrate composites. The salt hydrate composites fabricated using a dry mixing process can endure long-term cycling. Other advantages of a dry mixing process to fabricate a salt hydrate composite compared to a wet mixing process include:
reduced energy consumption during fabrication (i.e., more energy efficient);
reduced (or eliminated) agglomeration during cycling of the salt hydrate composite due to solid-state mixing (i.e., the salt hydrate never phase changed into liquid); and
ease of scaling the process (the mass content simply needs to be increased).

In some embodiments, a salt hydrate composite comprises a salt hydrate, a matrix material, and a binder. The matrix material imparts mechanical strength to the salt hydrate composite.

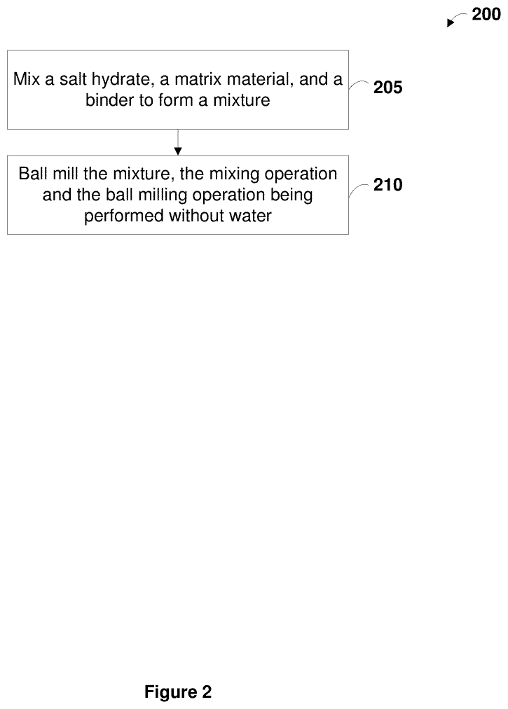

FIG. 2 shows an example of a flow diagram illustrating a manufacturing process for a salt hydrate composite. Starting at block 205 of the process 200 shown in FIG. 2, a salt hydrate, a matrix material, and a binder and mixed to form a mixture. At block 210, the mixture is ball milled. The mixing operation and the ball milling are performed without water. No water is added during the mixing operation or the ball milling operation. The mixing operation and the ball milling operation are both dry operations.

In some embodiments, the salt hydrate is a salt hydrate from a group SrCl₂·6H₂O, Na₃PO₄·12H₂O, SrBr₂·6H₂O, MgSO₄·7H₂O, and K₂CO₃·1.5H₂O. In some embodiments, the matrix material is a matrix material from a group graphene oxide (GO), single walled carbon nanotubes (SWCNTs), expanded graphite (EX), exfoliated graphite (EXG), and vermiculite. In some embodiments, the binder is a polymer-based binder or an aqueous binder. In some embodiments, the binder is a polymer-based binder from a group polyacrylonitrile (PAN), polyvinylidene fluoride (PVDF), and polytetrafluoroethylene (PTFE). In some embodiments, the binder is an aqueous binder from a group starch, styrene-butadiene rubber (SBR), xanthan gum, and carboxymethyl cellulose (CMC).

In some embodiments, ball milling is performed for about 6 hours to 18 hours, or about 12 hours.

In some embodiments, a particle size of particles of the salt hydrate prior to the mixing operation is about 500 microns or less. In some embodiments, a particle size of particles of the salt hydrate after the ball milling operation is about 2 microns to 10 microns.

In some embodiments, the mixture comprises about 50 wt % to 80 wt % salt hydrate, about 10 wt % to 48 wt % matrix material, and about 2 wt % to 10 wt % binder. In some embodiments, the mixture comprises about 75 wt % salt hydrate, about 20 wt % matrix material, and about 5 wt % binder.

In some embodiments, the process 200 further includes forming a compressed body of the mixture using the ball milled mixture. Water is not added to the ball milled mixture when forming the compressed body.

In some embodiments, prior to the mixing operation at block 205, the salt hydrate is processed such that particle sizes of particles of the salt hydrate about 500 microns or less. In some embodiments, processing the salt hydrate includes pulverizing the salt hydrate (e.g., manually with a mortal a pestle). In some embodiments, processing the salt hydrate includes performing hydrating-dehydrating cycles on the salt hydrate (e.g., greater than about 10 cycles).

In some embodiments, instead of ball milling the mixture at block 210, alternative equipment may be used, such as a high shear mixer, a ribbon mixer, or an induction mixer, for example. The mixture is processed in such alternative equipment without water.

The following examples are intended to be examples of the embodiments disclosed herein, and are not intended to be limiting.

### Example

Masses of strontium chloride hexahydrate and expanded graphite were measured based on the specified ratio. Measured components were then dry mixed using a ball mill rotating at 500 rpm for 30 minutes. Pellets were prepared by dry pressing at 500 psi. The pellet samples were then placed on a mesh inside an environmental chamber where they are cycled using the following conditions: heated to 80° C. at 5° C./min at 0% RH; held at isothermal for 30 minutes; cooled down to 25° ° C. at 5° C./min with 60% RH; held at 25° C. 60% RH for 3 hours.

### Example

Appropriate masses of salt hydrate (SrCl₂·6H₂O), the matrix material (expanded graphite), and binder (polyacrylonitrile (PAN) were measured so that a 75 wt % SrCl₂·6H₂O, 20 wt % expanded graphite, and 5 wt % PAN mixture could be formed. The SrCl₂·6H₂O, expanded graphite, and PAN were mixed to form a mixture. The mixture was then ball milled in a plastic container at 200 rpm for about 12 hours. Pellets were pressed in a ¾ inch die at 100 lbs.

### Example

Different compositions, host matrix materials, and polymer binders were tested and have been able to cycle for over >500 dehydration and hydration (charging/discharge) cycles. A salt hydrate composite comprising about 75 wt % salt hydrate, about 20 wt % graphene oxide, and about 5 wt % polyacrylonitrile binder showed a high stability both structurally and energy density.

### CONCLUSION

Further details regarding the embodiments described herein can be found in A. Martin et al., “Particle Size Optimization of Thermochemical Salt Hydrates for High Energy Density Thermal Storage,” Energy Environ. Mater. 2023, 0, e12544, which is herein incorporated by reference.

In the foregoing specification, the invention has been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of invention.

What is claimed is:

1. A method comprising:
mixing a salt hydrate, a matrix material, and a binder to form a mixture; and
ball milling the mixture, the mixing operation and the ball milling operation being performed without water.

2. The method of claim 1, further comprising:
prior to the mixing operation, processing the salt hydrate such that particle sizes of particles of the salt hydrate about 500 microns or less.

3. The method of claim 1, wherein the mixing operation and the ball milling operation are dry processes.

4. The method of claim 1, wherein water is not added in the mixing operation or in the ball milling operation.

5. The method of claim 1, wherein the salt hydrate is a salt hydrate from a group SrCl₂·6H₂O, Na₃PO₄·12H₂O, SrBr₂·6H₂O, MgSO₄·7H₂O, and K₂CO₃·1.5H₂O.

6. The method of claim 1, wherein the matrix material is a matrix material from a group graphene oxide (GO), single walled carbon nanotubes (SWCNTs), expanded graphite (EX), exfoliated graphite (EXG), and vermiculite.

7. The method of claim 1, wherein the binder is a polymer-based binder from a group polyacrylonitrile (PAN), polyvinylidene fluoride (PVDF), and polytetrafluoroethylene (PTFE).

8. The method of claim 1, wherein the binder is an aqueous binder from a group starch, styrene-butadiene rubber (SBR), xanthan gum, and carboxymethyl cellulose (CMC).

9. The method of claim 1, wherein the ball milling is performed for about 6 hours to 18 hours, or about 12 hours.

10. The method of claim 1, wherein a particle size of particles of the salt hydrate prior to the mixing operation is about 500 microns or less.

11. The method of claim 1, wherein a particle size of particles of the salt hydrate after the ball milling operation is about 2 microns to 10 microns.

12. The method of claim 1, wherein the mixture comprises about 50 wt % to 80 wt % salt hydrate, about 10 wt % to 48 wt % matrix material, and about 2 wt % to 10 wt % binder.

13. The method of claim 1, wherein the mixture comprises about 75 wt % salt hydrate, about 20 wt % matrix material, and about 5 wt % binder.

14. The method of claim 1, further comprising:
forming a compressed body of the mixture using the ball milled mixture, wherein water is not added to the ball milled mixture when forming the compressed body.
